(19) United States
(12) Patent Application Publication
(10) Pub. No.: US 2025/0307917 A1
(43) Pub. Date: Oct. 2, 2025

(54) ARTIFICIAL INTELLIGENCE BASED COMPUTING SYSTEM AND METHOD FOR GENERATING FINANCIAL APPLICATION FOR USERS

(71) Applicant: iCreditWorks, Iselin, NJ (US)

(72) Inventors: Shankar R Iyer, East Windsor, NJ (US); Suresh G Nair, Robbinsville Twp, NJ (US); Stephen E Sweeney, Mahwah, NJ (US)

(21) Appl. No.: 18/619,316

(22) Filed: Mar. 28, 2024

(51) Int. Cl. G06Q 40/03

(52) U.S. Cl. CPC G06Q 40/03

(57) ABSTRACT

An artificial intelligence based computing method for generating financial applications for second users, is disclosed. The AI-based computing method includes steps of: obtaining first data from first electronic devices associated with first users; determining first risk-based pricing options associated with projects; sending application links to second electronic devices associated with the second users for the second electronic devices to initiate applications; obtaining second data from the second electronic devices associated with the second users; determining whether the second users are qualified to obtain credits associated with projects; obtaining confirmed information associated with projects, from the second electronic devices of the second users; obtaining third data associated with identities of second users to map the second data with the third data; generating the financial applications for payment processes; and providing an output of the financial applications on user interface associated with the second electronic devices of the second users.

### FIELD OF INVENTION

Embodiments of the present disclosure relate to artificial intelligence based (AI-based) computing systems, and more particularly relates to an AI-based computing method and system for generating one or more financial applications for one or more users (e.g., one or more customers).

### BACKGROUND

The customary procedure for seeking financial assistance including at least one of: credit cards, personal loans, car loans, mortgages, and the like, typically involves an applicant (e.g., a customer) reaching out to a recipient (e.g., a lender), either in person or through a phone call. The applicant is then required to complete a loan application, either verbally or in writing, which is later reviewed by the lender. In some cases, there may be multiple lenders involved, allowing the applicant to evaluate costs and features of potential loans. If the lender rejects the loan application, the applicant may need to explore alternative lending options. Alternatively, an information or a finance broker (e.g., a vendor/merchant) can handle the task of consulting multiple lenders on behalf of the applicant, comparing available options.

In another aspect, if the applicant possesses favourable credit scores, and if the costs and features of the potential loans provided by the lenders/vendors are not satisfied to the applicant, the vendor/lender may have to convince the applicant for getting the loans from the lender. For this, the vendor communicates the applicant with the best offers (e.g., lower interest rates, discount rates, and the like) for convincing the applicants to obtain the loans. However, the procedures including at least one of: completing an application form, assembling required documents, participating in an interview with the lender, and validating submitted information, should be repeated until the applicant gets convinced for getting the loans.

Hence, the applicant needs to provide their information often when the vendor provides the best offers to the applicant. Further, the information needs to be verified manually whenever the applicant provides their information to the vendors, which consumes more time. Since, the manual process is involved in verification, the accuracy and efficiency of the loan approval process are not fulfilled.

Hence, there is a need for an improved artificial intelligence based (AI-based) computing system and method for automatic data mapping for one or more electronic documents, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence based (AI-based) computing method for generating one or more financial applications for one or more second users, is disclosed. The AI-based computing method comprises obtaining, by one or more hardware processors, one or more first data from one or more first electronic devices associated with one or more first users. The one or more first data comprise at least one of: name, phone number, and address, of the one or more second users, one or more project categories, estimation of one or more projects, and time duration of the one or more projects being completed.

The AI-based computing method further comprises determining, by the one or more hardware processors, one or more first risk-based pricing options associated with the one or more projects based on the one or more first data obtained from the one or more first electronic devices associated with the one or more first users.

The AI-based computing method further comprises sending, by the one or more hardware processors, one or more application links to one or more second electronic devices associated with the one or more second users for the one or more second electronic devices to initiate one or more applications.

The AI-based computing method further comprises obtaining, by the one or more hardware processors, one or more second data from the one or more second electronic devices associated with the one or more second users. The one or more second data comprise at least one of: the name, the phone number, the address, at least last four digits of a social security number (SSN), birth date, and annual income, of the one or more second users, an amount requested by the one or more second users, and an option for one or more third users to be added to the one or more second users.

The AI-based computing method further comprises determining, by the one or more hardware processors, whether the one or more second users are qualified to obtain one or more credits associated with the one or more projects by an artificial intelligence (AI) model.

The AI-based computing method further comprises sending, by the one or more hardware processors, the determined one or more first risk-based pricing options associated with the one or more projects to the one or more second electronic devices of the one or more second users when the one or more second users are qualified to obtain the one or more credits associated with the one or more projects.

The AI-based computing method further comprises determining, by the one or more hardware processors, whether the one or more second electronic devices of the one or more second users accept the one or more first risk-based pricing options associated with the one or more projects.

The AI-based computing method further comprises determining, by the one or more hardware processors, one or more second risk-based pricing options associated with the one or more projects to be sent to the one or more second electronic devices of the one or more second users when the one or more second electronic devices of the one or more second users reject the one or more first risk-based pricing options associated with the one or more projects.

The AI-based computing method further comprises obtaining, by the one or more hardware processors, one or more confirmed information associated with the one or more projects, from the one or more second electronic devices of the one or more second users.

The one or more confirmed information associated with the one or more projects comprise at least one of: one or more names associated with the one or more first users, one or more categories of works associated with the one or more projects, estimation of the works associated with the one or more projects, the time duration of the one or more projects, information associated with one or more ownerships, one or more categories of one or more properties of the one or more second users.

The AI-based computing method further comprises obtaining, by the one or more hardware processors, one or more third data associated with one or more identities of the one or more second users to map the one or more second data with the one or more third data.

The AI-based computing method further comprises generating, by the one or more hardware processors, the one or more financial applications comprising one or more agreement based electronic documents for one or more payment processes, wherein the one or more agreement based electronic documents comprise at least one of: information associated with one or more credit amounts, and one or more truth in lending agreements (TILA).

The AI-based computing method further comprises providing, by the one or more hardware processors, an output of the generated one or more financial applications in form of the one or more agreement based electronic documents on a user interface associated with the one or more second electronic devices of the one or more second users.

In an embodiment, the AI-based computing method further comprises: (a) selecting, by the one or more hardware processors, the one or more projects from a list of one or more ongoing projects associated with the one or more second users; (b) generating, by the one or more hardware processors, one or more first options associated with the one or more projects; (c) obtaining, by the one or more hardware processors, at least one first option associated with the one or more projects selected by the one or more first electronic devices of the one or more first users; (d) sending, by the one or more hardware processors, the at least one first option selected by the one or more first electronic devices of the one or more first users, to the one or more second electronic devices of the one or more second users; (e) determining, by the one or more hardware processors, whether the one or more second users accept the at least one first option through the one or more second electronic devices; (e) initiating, by the one or more hardware processors, the one or more payment processes when the one or more second electronic devices of the one or more second users accept the at least one first option; and (f) re-sending, by the one or more hardware processors, the at least one first option selected by the one or more first electronic devices of the one or more first users, to the one or more second electronic devices of the one or more second users, upon contacting with the one or more second users through the one or more second electronic devices when the one or more second users reject the at least one first option through the one or more second electronic devices.

The one or more first options comprise at least one of: creation of one or more payment requests, one or more update statuses of the one or more projects, one or more updated details of the one or more projects.

In another embodiment, determining, by the artificial intelligence (AI) model, whether the one or more second users are qualified to obtain one or more credits associated with the one or more projects, comprises: (a) obtaining, by the one or more hardware processors, the one or more second data from the one or more second electronic devices associated with the one or more second users; (b) comparing, by the one or more hardware processors, the one or more second data associated with the one or more second users with one or more predetermined data; and (c) determining, by the one or more hardware processors, whether the one or more second users are qualified to obtain the one or more credits associated with the one or more projects, based on the comparison of the one or more second data associated with the one or more second users with the one or more predetermined data. The one or more predetermined data comprise one or more prestored results associated with one or more qualifications of the one or more second users for the one or more credits based on data associated with the one or more second users.

In yet another embodiment, the AI-based computing method further comprises: (a) providing, by the one or more hardware processors, one or more second options to the one or more second electronic devices of the one or more second users to add the one or more third users; (b) obtaining, by the one or more hardware processors, one or more fourth data associated with the one or more third users from at least one of: the one or more second electronic devices of the one or more second users and one or more third electronic devices of the one or more third users. The one or more fourth data associated with the one or more third users comprise at least one of: the name, the phone number, the address, the at least last four digits of a social security number (SSN), the birth date, and the annual income, of the one or more third users.

In yet another embodiment, the AI-based computing method further comprises: (a) determining, by the one or more hardware processors, whether the one or more second users hold at least one of: the one or more first risk-based pricing options and the one or more second risk-based pricing options, associated with the one or more projects within a predetermined time duration; and (b) sending, by the one or more hardware processors, one or more reminder messages to at least one of: the one or more first electronic devices of the one or more first users and the one or more second electronic devices of the one or more second users when the one or more second users hold at least one of: the one or more first risk-based pricing options and the one or more second risk-based pricing options, associated with the one or more projects within the predetermined time duration.

In yet another embodiment, the AI-based computing method further comprises: (a) generating, by the one or more hardware processors, one or more summaries associated with the one or more credits to be sent to the one or more second electronic devices of the one or more second users upon mapping of the one or more second data with the one or more third data; (b) determining, by the one or more hardware processors, one or more credit qualifications of the one or more second users based on a hard pull process through a global distribution system (GDS); and (c) generating, by the one or more hardware processors, the one or more financial applications in the form of the one or more agreements for one or more payment processes when the one or more credit qualifications of the one or more second users exceed one or more predetermined value.

In yet another embodiment, the AI-based computing method further comprises validating, by the one or more hardware processors, the one or more first users based on a clear identity confirm process.

In yet another embodiment, validating, by the one or more hardware processors, the one or more first users based on the clear identity confirm process, comprises: (a) obtaining, by the one or more hardware processors, one or more fifth data associated with the one or more first users from the one or more first electronic devices of the one or more first users; (b) comparing, by the one or more hardware processors, the one or more fifth data associated with the one or more first users with one or more first prestored data associated with the one or more first users retrieved from one or more clear databases; (c) generating, by the one or more hardware processors, one or more confidence scores for the one or more first users based on the comparison of the one or more fifth data associated with the one or more first users with the one or more first prestored data associated with the one or more first users; (d) classifying, by the one or more hardware processors, the one or more first users based on the one or more confidence scores generated for the one or more first users; and (e) determining, by the one or more hardware processors, whether the one or more first electronic devices of the one or more first users need to provide one or more sixth data based on the classification of the one or more first users.

In yet another embodiment, further comprising: (a) obtaining, by the one or more hardware processors, one or more inputs from the one or more first electronic devices of the one or more first users; (b) comparing by the one or more hardware processors, the one or more inputs with one or more second prestored data based on a clear risk inform search process; (c) generating, by the one or more hardware processors, one or more risk scores for the one or more first users based on the comparison of the one or more inputs with the one or more second prestored data; and (d) determining, by the one or more hardware processors, one or more optimum first users based on the one or more risk scores generated for the one or more first users. The one or more inputs comprise a selection of one or more entities on which the one or more first users are belonging to.

In one aspect, an artificial intelligence based (AI-based) computing system for generating one or more financial applications for one or more second users, is disclosed. The AI-based computing system includes one or more hardware processors and a memory coupled to the one or more hardware processors. The memory includes a plurality of subsystems in the form of programmable instructions executable by the one or more hardware processors.

The plurality of subsystems comprises a data obtaining subsystem configured to obtain one or more first data from one or more first electronic devices associated with one or more first users. The one or more first data comprise at least one of: a name, a phone number, and an address, of the one or more second users, one or more project categories, an estimation of one or more projects, and a duration of the one or more projects being completed.

The plurality of subsystems further comprises a risk-based price determining subsystem configured to determine one or more first risk-based pricing options associated with the one or more projects based on the one or more first data obtained from the one or more first electronic devices associated with one or more first users.

The plurality of subsystems further comprises a data transmission subsystem configured to send one or more application links to one or more second electronic devices associated with the one or more second users for the one or more second electronic devices to initiate one or more applications.

The plurality of subsystems further comprises the data obtaining subsystem configured to obtain one or more second data from the one or more second electronic devices associated with the one or more second users. The one or more second data comprise at least one of: the name, the phone number, the address, at least last four digits of a social security number (SSN), birth date, and annual income, of the one or more second users, an amount requested by the one or more second users, and an option for one or more third users to be added to the one or more second users.

The plurality of subsystems further comprises a qualification determining subsystem configured to determine whether the one or more second users are qualified to obtain one or more credits associated with the one or more projects by an artificial intelligence (AI) model.

The plurality of subsystems further comprises the data transmission subsystem further configured to send the determined one or more first risk-based pricing options associated with the one or more projects to the one or more second electronic devices of the one or more second users when the one or more second users are qualified to obtain the one or more credits associated with the one or more projects.

The plurality of subsystems further comprises the risk-based price determining subsystem further configured to: (a) determine, whether the one or more second electronic devices of the one or more second users accept the one or more first risk-based pricing options associated with the one or more projects; and (b) determine one or more second risk-based pricing options associated with the one or more projects to be sent to the one or more second electronic devices of the one or more second users when the one or more second electronic devices of the one or more second users reject the one or more first risk-based pricing options associated with the one or more projects.

The plurality of subsystems further comprises the data obtaining subsystem further configured to: (a) obtain one or more confirmed information associated with the one or more projects, from the one or more second electronic devices of the one or more second users; and obtain one or more third data associated with one or more identities of the one or more second users to map the one or more second data with the one or more third data.

The one or more confirmed information associated with the one or more projects comprise at least one of: one or more names associated with the one or more first users, one or more categories of works associated with the one or more projects, estimation of the works associated with the one or more projects, the time duration of the one or more projects, information associated with one or more ownerships, one or more categories of one or more properties of the one or more second users.

The plurality of subsystems further comprises a financial application generation subsystem configured to generate the one or more financial applications comprising one or more agreement based electronic documents for one or more payment processes. The one or more agreement based electronic documents comprise at least one of: information associated with one or more credit amounts, and one or more truth in lending agreements (TILA).

The plurality of subsystems further comprises an output subsystem configured to provide an output of the generated one or more financial applications in form of the one or more agreement based electronic documents on a user interface associated with the one or more second electronic devices of the one or more second users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with an artificial intelligence based (AI-based) computing system for generating one or more financial applications for one or more second users, in accordance with an embodiment of the present disclosure;

FIG. 2 is a detailed view of the AI-based computing system for generating the one or more financial applications for the one or more second users, in accordance with another embodiment of the present disclosure;

FIG. 3 is an overall process flow of generating the one or more financial applications for the one or more second users, in accordance with another embodiment of the present disclosure; and

FIG. 4 is a flow chart illustrating an artificial intelligence based (AI-based) computing method for generating the one or more financial applications for the one or more second users, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

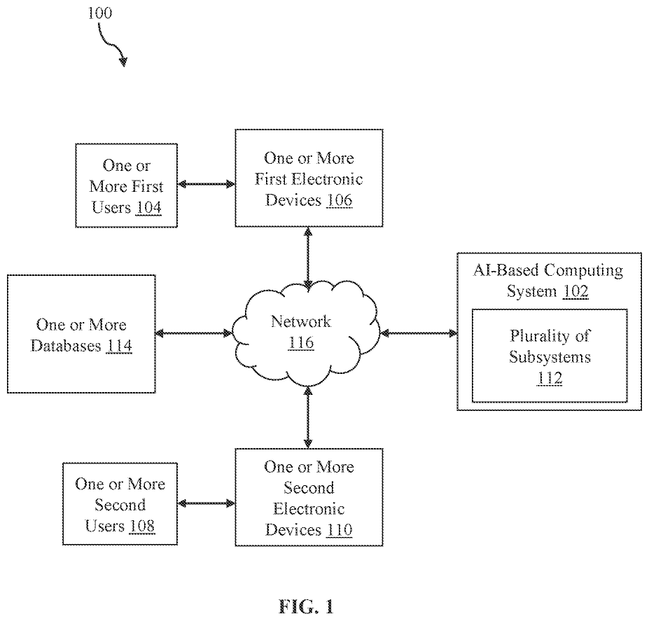

Referring now to the drawings, and more particularly to FIG. 1 through FIG. 4, where similar reference characters denote corresponding features consistently throughout the figures, there are shown preferred embodiments and these embodiments are described in the context of the following exemplary system and/or method.

FIG. 1 is a block diagram illustrating a computing environment 100 with an artificial intelligence based (AI-based) computing system 102 for generating one or more financial applications for one or more second users 108, in accordance with an embodiment of the present disclosure. According to FIG. 1, the computing environment 100 includes one or more first electronic devices 106 and one or more second electronic devices 110, which are communicatively coupled to the AI-based computing system 102 through a network 116. The one or more first electronic devices 106 and the one or more second electronic devices 110, through which one or more first users 104 and the one or more second users 108 respectively provide one or more inputs to the AI-based computing system 102.

In an embodiment, the one or more first users 104 may include at least one of: one or more vendors, one or more merchants, one or more brokers, one or more contractors, and the like. In an embodiment, the one or more second users 108 may include one or more customers, one or more organizations, one or more individuals within the one or more organizations, and the like.

The present invention is configured to generate the one or more financial applications for the one or more second users (e.g., one or more customers/consumers) 108 for seeking one or more credits (e.g., one or more home improvement loans). The present invention is further configured to generate the one or more financial applications for the one or more first users 104 and the one or more second users 108 to generate quotes (risk-based pricing options/offers) for one or more projects (e.g., one or more home improvement projects). The present invention is configured to generate one or more payment processes on a contract and needs of the one or more first users 104 and the one or more second users 108.

The AI-based computing system 102 is initially configured to obtain one or more first data from the one or more first electronic devices 106 associated with the one or more first users 104. In an embodiment, the one or more first data may include at least one of: name, phone number, and address, of the one or more second users 108, one or more project categories, estimation of one or more projects, and time duration of the one or more projects being completed. The AI-based computing system 102 is further configured to determine one or more first risk-based pricing options associated with the one or more projects based on the one or more first data obtained from the one or more first electronic devices 106 associated with the one or more first users 104.

The AI-based computing system 102 is further configured to send one or more application links to one or more second electronic devices 110 associated with the one or more second users 108 for the one or more second electronic devices 110 to initiate one or more applications. The AI-based computing system 102 is further configured to obtain one or more second data from the one or more second electronic devices 110 associated with the one or more second users 108. The one or more second data may include at least one of: the name, the phone number, the address, at least last four digits of a social security number (SSN), birth date, and annual income, of the one or more second users 108, an amount requested by the one or more second users 108, and an option for one or more third users to be added to the one or more second users 108.

The AI-based computing system 102 is further configured to determine whether the one or more second users 108 are qualified to obtain one or more credits associated with the one or more projects by an artificial intelligence (AI) model. The AI-based computing system 102 is further configured to send the determined one or more first risk-based pricing options associated with the one or more projects when the one or more second users 108 are qualified to obtain the one or more credits associated with the one or more projects. The AI-based computing system 102 is further configured to determine whether the one or more second users 108 accept the one or more first risk-based pricing options associated with the one or more projects. The AI-based computing system 102 is further configured to determine one or more second risk-based pricing options associated with the one or more projects to be sent to the one or more second electronic devices 110 of the one or more second users 108 when the one or more second users 108 reject the one or more first risk-based pricing options associated with the one or more projects.

The AI-based computing system 102 is further configured to obtain one or more confirmed information associated with the one or more projects, from the one or more second electronic devices 110 of the one or more second users 108. In an embodiment, the one or more confirmed information associated with the one or more projects may include at least one of: one or more names associated with the one or more first users 104, one or more categories of works associated with the one or more projects, estimation of the works associated with the one or more projects, the time duration of the one or more projects, information associated with one or more ownerships, one or more categories of one or more properties of the one or more second users 108.

The AI-based computing system 102 is further configured to obtain one or more third data associated with one or more identities of the one or more second users 108 to map the one or more second data with the one or more third data. The AI-based computing system 102 is further configured to generate the one or more financial applications including one or more agreement based electronic documents for one or more payment processes. The one or more agreement based electronic documents may include at least one of: information associated with one or more credit amounts, and one or more truth in lending agreements (TILA). The AI-based computing system 102 is further configured to provide an output of the generated the one or more financial applications in form of the one or more agreement based electronic documents on a user interface associated with the one or more second electronic devices 110 of the one or more second users 108.

The AI-based computing system 102 may be hosted on a central server including at least one of: a cloud server or a remote server. In an embodiment, the AI-based computing system 102 may include at least one of: a user device, a server computer, a server computer over the network 116, a cloud-based computing system, a cloud-based computing system over the network 116, a distributed computing system, and the like. Further, the network 116 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more first electronic devices 106 and the one or more second electronic devices 110, may include at least one of: a laptop computer, a desktop computer, a tablet computer, a Smartphone, a wearable device, a Smart watch, and the like.

Further, the computing environment 100 includes one or more databases 114 communicatively coupled to the AI-based computing system 102 through the network 116. Furthermore, the one or more first electronic devices 106 and the one or more second electronic devices 110, may include at least one of: a local browser, a mobile application, and the like.

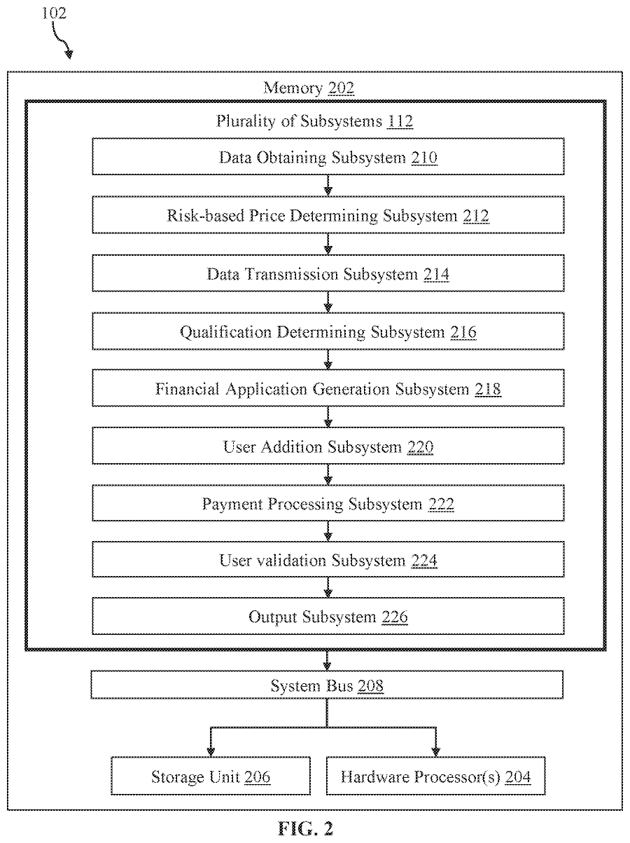

Furthermore, the one or more first users 104 and the one or more second users 108, may use a web application through the local browser, the mobile application to communicate with the AI-based computing system 102. In an embodiment of the present disclosure, the AI-based computing system 102 includes a plurality of subsystems 112. Details on the plurality of subsystems 112 have been elaborated in subsequent paragraphs of the present description with reference to FIG. 2.

FIG. 2 is a detailed view of the AI-based computing system 102 for generating the one or more financial applications for the one or more second users 108, in accordance with another embodiment of the present disclosure. The AI-based computing system 102 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 112 in the form of programmable instructions executable by the one or more hardware processors 204.

The plurality of subsystems 112 includes a data obtaining subsystem 210, a risk-based price determining subsystem 212, a data transmission subsystem 214, a qualification determining subsystem 216, a financial application generation subsystem 218, a user addition subsystem 220, a payment processing subsystem 222, a user validation subsystem 224, and an output subsystem 226.

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 112 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 112.

The plurality of subsystems 112 includes the data obtaining subsystem 210 that is communicatively connected to the one or more hardware processors 204. The data obtaining subsystem 210 is configured to obtain the one or more first data from one or more first electronic devices 106 associated with the one or more first users (e.g., vendor/merchant) 104 upon the first one or more users 104 log in to a provider application. In an embodiment, an user interface of the provider application is configured to display one or more options based on a status of the one or more projects. For example, the user interface of the provider application is configured to provide an option for the one or more first users 104 to initiate a new project.

The data obtaining subsystem 210 in the application is configured to obtain at least one of: the name, the phone number, and the address, of the one or more second users 108, the one or more project categories, the estimation of one or more projects, and the duration of the one or more projects being completed. In an embodiment, the one or more project categories may be selected from, but not limited to, at least one of: bathroom, kitchen, landscaping/outdoor project, new addition, roofing, flooring, heating, ventilation, and air conditioning (HVAC), and the like.

The plurality of subsystems 112 includes the risk-based price determining subsystem 212 that is communicatively connected to the one or more hardware processors 204. The risk-based price determining subsystem 212 is configured to determine the one or more first risk-based pricing options associated with the one or more projects based on the one or more first data obtained from the one or more first electronic devices 106 associated with one or more first users 104. In an embodiment, the risk-based price determining subsystem 212 is configured to select the one or more first risk-based pricing options before an application link is sent to the one or more second users (e.g., one or more consumers/customers/responsible party (RP)) 108.

In an embodiment, the risk-based price determining subsystem 212 is configured to change the one or more first risk-based pricing options before sending the application link to the one or more second users 108. The one or more first risk-based pricing options are options that is seen by the one or more second users 108 when the application is approved. The risk-based price determining subsystem 212 is further configured to save the information.

The plurality of subsystems 112 includes the data transmission subsystem 214 that is communicatively connected to the one or more hardware processors 204. The data transmission subsystem 214 is configured to send the one or more application links to the one or more second electronic devices 110 associated with the one or more second users 108 for the one or more second electronic devices 110 to initiate the one or more applications. In an embodiment, the one or more application links are sent to the one or more second users 108 through at least one of: a short message sent (SMS), an electronic mail, a social media, and the like.

When the one or more second users 108 are adapted to click on the one or more application links, the data transmission subsystem 214 is configured to send a message on the application confirming that the one or more application links are received by the one or more second users 108 and the one or more second users 108 have initiated the application. The notification may be sent to the one or more first users 104 and the application. In an embodiment, the status of the application may be updated to “in progress”. In an embodiment, the one or more second users 108 may download the application using at least one of: a quick response (QR) code and one or more play stores.

The application is configured to display one or more names and one or more phone numbers of the one or more second users 108 on a welcome screen with an option for “This is not me”. The option “This is not me” may be appeared when the one or more phone numbers used by the one or more second users 108 are not correct. If an intended recipient of the one or more application links is wrong, the application may terminate with a message to the one or more first users 104 and may inform the one or more first users 104 to update the one or more phone numbers and to resubmit. The application is configured to display the recipient a blank screen. The option “This is not me” may further be appeared when the information entered by the one or more first users 104 have errors in the information. In an embodiment, the application may allow the one or more second users 108 to update that information manually through the one or more second electronic devices 110.

When the one or more second users 108 update the information, the data transmission subsystem 214 is further configured to send a message back to the one or more first users 104 through the SMS. The message notifies that the one or more second users 108 has updated the information. The data transmission subsystem 214 may be configured to connect any information that the one or more second users 108 input on the application. In an embodiment, if the one or more second users 108 uses the QR code to connect to the one or more first users 104. The AI-based computing system 102 is configured to determine whether the QR code is specific or generic, and to determine whether the one or more second electronic devices 110 of the one or more second users 108 is configured to search for the one or more first users 104 to select the one or more first users 104. The AI-based computing system 102 is further configured to connect the one or more first users 104 to the one or more second users 108.

The data obtaining subsystem 210 is further configured to obtain the one or more second data from the one or more second electronic devices 110 associated with the one or more second users 108 when the one or more second electronic devices 110 of the one or more second users 108 are configured to click on the one or more application links associated with the one or more projects. In an embodiment, the one or more second data may include at least one of: the name, the phone number, the address, at least last four digits of a social security number (SSN), birth date, and annual income, of the one or more second users 108, an amount requested by the one or more second users 108, and an option for one or more third users to be added to the one or more second users 108.

In an embodiment, at least one of: the name, the phone number, the address, of the one or more second users 108 may be easily updated by an editing option. In an embodiment, if the address of the one or more second users 108 is not where the work would be performed, the data obtaining subsystem 210 is configured to obtain the working address of the one or more projects from the one or more second electronic devices 110 of the one or more second users 108. In an embodiment, if the address of the one or more second users 108 is a commercial property, then the data obtaining subsystem 210 is configured to obtain the address associated with the commercial property from the one or more second electronic devices 110 of the one or more second users 108. In an embodiment, if the address of the one or more second users 108 is at least one of: a primary address and a vacation home, then the data obtaining subsystem 210 is configured to obtain the address associated with at least one of: the primary address and the vacation home from the one or more second electronic devices 110 of the one or more second users 108. In an embodiment, the data obtaining subsystem 210 is configured to generate a message to the one or more second electronic devices 110 of the one or more second users 108 indicating that the AI-based computing system 102 does not accept non-primary residence addresses of the one or more second users 108 at a moment.

The plurality of subsystems 112 includes the qualification determining subsystem 216 that is communicatively connected to the one or more hardware processors 204. The qualification determining subsystem 216 is configured to obtain the one or more second data and verify the one or more second data from prove before prequal is submitted. In an embodiment, the data obtaining subsystem 210 is configured to obtain additional data from the one or more second electronic devices 110 of the one or more second users 108. The qualification determining subsystem 216 is further configured to determine whether the one or more second users 108 are qualified to obtain one or more credits (e.g., one or more loans) associated with the one or more projects by the artificial intelligence (AI) model. In an embodiment, the artificial intelligence (AI) model may include at least one of: a deep neural networks based AI model, a linear regression based AL model, a logistic regression based AL model, a decision trees based AL model, a random forest based AL model, and the like.

For determining whether the one or more second users 108 are qualified to obtain one or more credits associated with the one or more projects, the qualification determining subsystem 216 using the artificial intelligence (AI) model, is configured to obtain the one or more second data from the one or more second electronic devices 110 associated with the one or more second users 108. The qualification determining subsystem 216 is further configured to compare the one or more second data associated with the one or more second users 108 with one or more predetermined data. In an embodiment, the one or more predetermined data may include one or more prestored results associated with one or more qualifications of the one or more second users 108 for the one or more credits based on data associated with the one or more second users 108. For example, one or more prestored results associated with one or more qualifications of the one or more second users 108 may include at least one of: educational qualifications of the one or more second users 108, credit scores of the one or more second users 108, credit history of the one or more second users 108, transaction statuses of the one or more second users 108, and the like. The qualification determining subsystem 216 is further configured to determine whether the one or more second users 108 are qualified to obtain the one or more credits associated with the one or more projects, based on the comparison of the one or more second data associated with the one or more second users 108 with the one or more predetermined data.

If the one or more second users 108 are qualified, then the qualification determining subsystem 216 may terminate the application and may decline an adverse action notice (AAN) to the one or more second electronic devices 110 of the one or more second users 108. The qualification determining subsystem 216 is further configured to determine whether the one or more second users 108 are approved for a partial loan amount. The qualification determining subsystem 216 is configured to show a partial AAN along with an option to one or more third users (e.g., one or more co-applicants). If the one or more second users 108 declines to add the one or more third users within a predetermined time period (e.g., one month), the qualification determining subsystem 216 may terminate the application and may decline an adverse action notice (AAN) to the one or more second electronic devices 110 of the one or more second users 108.

The plurality of subsystems 112 includes the user addition subsystem 220 that is communicatively connected to the one or more hardware processors 204. If the one or more second users 108 want to add the one or more third users, the user addition subsystem 220 is configured to provide options (e.g., one or more second options) to the one or more second electronic devices 110 of the one or more second users 108 to add the one or more third users. The user addition subsystem 220 is configured to obtain one or more fourth data associated with the one or more third users from at least one of: the one or more second electronic devices 110 of the one or more second users 108 and one or more third electronic devices of the one or more third users. In an embodiment, the one or more fourth data associated with the one or more third users may include at least one of: the name, the phone number, the address, the at least last four digits of a social security number (SSN), the birth date, and the annual income, of the one or more third users.

In an embodiment, the user addition subsystem 220 is configured to repeat the process until the one or more third users are added. In an embodiment, the user addition subsystem 220 is further configured to terminate the application when the one or more second electronic devices 110 of the one or more second users 108 decide not to proceed with the partial amount and the one or more second electronic devices 110 of the one or more second users 108 are unable to add the one or more third electronic devices of the one or more third users. The qualification determining subsystem 216 is further configured to determine whether the one or more second users 108 are approved for a full loan amount or the partial loan amount. The risk-based price determining subsystem 212 is further configured to send the one or more first risk-based pricing options associated with the one or more projects, to the one or more second electronic devices 110 of the one or more second users 108.

The risk-based price determining subsystem 212 is further configured to determine whether the one or more second users 108 accept the one or more first risk-based pricing options associated with the one or more projects. The risk-based price determining subsystem 212 is further configured to determine the one or more second risk-based pricing options associated with the one or more projects to be sent to the one or more second electronic devices 110 of the one or more second users 108 when the one or more second users 108 reject the one or more first risk-based pricing options associated with the one or more projects. The risk-based price determining subsystem 212 is further configured to determine one or more subsequent risk-based pricing options associated with the one or more projects and to send the one or more subsequent risk-based pricing options to the one or more second electronic devices 110 of the one or more second users 108.

If the one or more second electronic devices 110 of the one or more second users 108 do not select the one or more risk-based pricing options associated with the one or more projects, the application may display the AAN to the one or more second electronic devices 110 of the one or more second users 108 and the process may be terminated. In the meantime, one or more reminder messages are sent to at least one of: the one or more second electronic devices 110 of the one or more second users 108 and the one or more first electronic devices 106 of the one or more first users 104, to complete the application.

When the one or more second electronic devices 110 of the one or more second users 108 accept the one or more risk-based pricing options (e.g., one or more loan offers), the one or more second users 108 are directed to a registration screen of the application where the one or more second users 108 create log in identity and password to enter into the application. At this stage, the one or more second users 108 are able to proceed once the one or more first users 104 enter all the information associated with the one or more projects. When the information is not available then the data transmission subsystem 214 is configured to send a message to the one or more first users 104.

Further, the data obtaining subsystem 210 is configured to obtain the one or more confirmed information associated with the one or more projects, from the one or more second electronic devices 110 of the one or more second users 108. The one or more confirmed information associated with the one or more projects may include at least one of: one or more names associated with the one or more first users 104, one or more categories of works associated with the one or more projects, estimation of the works associated with the one or more projects, the time duration of the one or more projects, information associated with one or more ownerships, one or more categories of one or more properties of the one or more second users 108. The information associated with one or more ownerships may be at least one of: owner occupied, joint owners, rental, vacation home, and the like. The one or more categories of one or more properties of the one or more second users 108 may include at least one of: single family, apartment, condo/town house, and the like.

The data transmission subsystem 214 is configured to send a notification message to the one or more first electronic devices 106 of the one or more first users 104 when the one or more second users 108 submit the one or more confirmed information associated with the one or more projects. The data obtaining subsystem 210 is further configured to obtain the one or more third data associated with the one or more identities of the one or more second users 108 to map the one or more second data with the one or more third data. For example, the one or more second electronic devices 110 are adapted to take a picture of government-issued photo id of the one or more second users 108, which is uploaded and verified against the one or more second data obtained earlier. In an embodiment, the data obtaining subsystem 210 must obtain both sides of the identity of the one or more second users 108 for identifying name and address.

Further, the one or more electronic devices 110 are adapted to take a selfie photograph of the one or more second users 108. The one or more second electronic devices 110 are adapted to take a liveliness check with blinking of eyes of the one or more second users 108. The application is terminated with the AAN when the results are not matched.

The plurality of subsystems 112 includes the financial application generation subsystem 218 that is communicatively connected to the one or more hardware processors 204. The financial application generation subsystem 218 is configured to generate the one or more financial applications including the one or more agreement based electronic documents for the one or more payment processes. The one or more agreement based electronic documents may include at least one of: the information associated with the one or more credit amounts, and the one or more truth in lending agreements (TILA).

The financial application generation subsystem 218 is configured to generate one or more summaries associated with the one or more credits to be sent to the one or more second electronic devices 110 of the one or more second users 108 upon mapping of the one or more second data with the one or more third data. The financial application generation subsystem 218 is further configured to determine one or more credit qualifications of the one or more second users 108 based on a hard pull process through a global distribution system (GDS). The financial application generation subsystem 218 is further configured to generate the one or more financial applications in the form of the one or more agreements for one or more payment processes when the one or more credit qualifications of the one or more second users 108 exceed one or more predetermined values.

When the one or more second users 108 are determined to be qualified for the getting the one or more credits, the application for the loan offers to the one or more second users 108, is approved. The one or more second electronic devices 110 obtain one or more autopay information from the one or more second users 108 through at least one of: linking account to pay, capturing bank account information from a check routing number and account number, and information associated with one or more financial devices (e.g., debit card, credit card, and the like).

The financial application generation subsystem 218 is configured to show credit score and payment details to be paid to the one or more second electronic devices 110 of the one or more second users 108. The financial application generation subsystem 218 is further configured to show at least one of: master promissory note (MPN), and an agreement. The financial application generation subsystem 218 is further configured to allow the one or more second users 108 to digitally sign and date of the agreement. The financial application generation subsystem 218 is further configured to show the one or more electronic regulatory documents including at least one of: exact loan amount (ELA), the truth in lending agreement (TILA), and the like.

The plurality of subsystems 112 includes the output subsystem 226 that is communicatively connected to the one or more hardware processors 204. The output subsystem 226 is configured to provide the output of the generated the one or more financial applications in form of the one or more agreement based electronic documents on a user interface associated with the one or more second electronic devices 110 of the one or more second users 108.

The plurality of subsystems 112 includes the payment processing subsystem 222 that is communicatively connected to the one or more hardware processors 204. The payment processing subsystem 222 is configured to select the one or more projects from a list of one or more ongoing projects associated with the one or more second users 108. The payment processing subsystem 222 is further configured to generate one or more options (i.e., one or more first options) associated with the one or more projects. In an embodiment, the one or more first options may include at least one of: creation of one or more payment requests, one or more update statuses of the one or more projects, one or more updated details of the one or more projects.

The payment processing subsystem 222 is further configured to obtain at least one first option (e.g., creation of one or more payment requests) associated with the one or more projects selected by the one or more first electronic devices 106 of the one or more first users 104. In an embodiment, the one or more first electronic devices 106 of the one or more first users 104 may have an option to select a percentage of a total amount from 0 to 100% (in increments of 10) or to input an amount (i.e., greater than the total cost of the one or more projects and greater than the approved amount). In another embodiment, the one or more first electronic devices 106 of the one or more first users 104 may have an option to include one or more pictures of completed work associated with the one or more projects.

The one or more first electronic devices 106 of the one or more first users 104 is configured to submit a request, which triggers a notification message to the one or more second electronic devices 110 of the one or more second users 108. The one or more second electronic devices 110 of the one or more second users 108 are configured to show “tasks” in the application so that the one or more second users 108 aware on a required action when the one or more second users 108 are logged in to the application. Upon clicking “tasks”, the payment processing subsystem 222 is configured to display the payment request. The second electronic devices 110 of the one or more second users 108 may be configured to either accept or reject the payment request.

If the one or more second electronic devices 110 of the one or more second users 108 choose to reject the payment request, the payment processing subsystem 222 is configured to allow the second electronic devices 110 of the one or more second users 108 to confirm the decision before rejecting the payment request. If rejecting the payment, the payment processing subsystem 222 is configured to contact the one or more first electronic devices 106 of the one or more first users 104 to communicate reasons for rejections and to resubmit the payment request. The payment processing subsystem 222 is further configured to send a notification message to the one or more first electronic devices 106 of the one or more first users 104, indicating that the one or more second electronic devices 110 of the one or more second users 108 has rejected the payment request and should be contacted to resolve the payment request.

If the one or more second electronic devices 110 of the one or more second users 108 take no action on the above said payment processes, the payment processing subsystem 222 is configured to send one or more reminders in a predetermined time duration. In an embodiment, the one or more first electronic devices 106 of the one or more first users 104 may also get the one or more reminders that the one or more second electronic devices 110 of the one or more second users 108 has not taken any action on the payment processes and the one or more first electronic devices 106 of the one or more first users 104 must contact the one or more second electronic devices 110 of the one or more second users 108.

The payment processing subsystem 222 is configured to initiate the one or more payment processes when the one or more second electronic devices 110 of the one or more second users 108 accept the at least one first option. In an embodiment, If the payment request is the first payment request, then the loan will be considered as funded/originated at this point. If the payment request is the last payment request, then the project will be marked as completed for both the one or more first users 104 and the one or more second users 108.

The plurality of subsystems 112 includes the user validation subsystem 224 that is communicatively connected to the one or more hardware processors 204. Out of network, the one or more first users 104 may search for the application on a web and from the “join the network” page, the one or more first users 104 join the network by entering their phone number and other information. The one or more first users 104 may receive a text message and may download the application on the one or more first electronic devices 106. An in-network first users 104 may receive a hot link from their enterprise and when the first users 104 download the application, one or more required information may be prepopulated. The data obtaining subsystem 210 is configured to obtain below information through the application.

First User 104 Completing the application

| | | |
|---|---|---|
| First Name | Last Name | Position within the |
| | | company |
| Email | Work Phone | Mobile Phone |

Information about the Business

| | | |
|---|---|---|
| Business Category (s) | Legal Business Name | Website/Business |
| | | URL |
| Are you an owner | Sponsor No/Referred by | Federal Tax ID |
| | | number |
| Contractor License and state | All names you are doing | In Business Since |
| | business as | MM/DD/YYYY |
| Business Structure (drop | Types of services (fill in the | Annual Consumer |
| down) | blank) | Sales per Year |
| Current Annual Finance | Average Size project, dollars | Physical Address of |
| Volume | | the business |
| Mailing address of the | Primary Customer Credit/ | Primary Financial |
| business (box)to check if | Service. Name, Email, | Contact. Name, email, |
| same ad physical address) | Mobile No. Work Phone | Mobile No., Work |
| | Number | Phone Number. |
| Business Banking | | |
| Information: Bank Name, | | |
| Name on Bank Account, | | |
| Routing Number, Account | | |
| Number | | |

Principal/Owner with the largest percentage of the business
(must be the majority shareholder . . . per SES 8/30

| | | |
|---|---|---|
| Full Name | Residential address | Mobile Phone |
| Email | Date of Birth | Social Security |
| | | Number |
| Owner since MM/YYYY | Job Title | Percent of Ownership |

The user validation subsystem 224 is configured to validate the one or more first users 104 based on a clear identity confirm process. For validating the one or more first users 104, the user validation subsystem 224 is configured to obtain one or more fifth data associated with the one or more first users 104 from the one or more first electronic devices 106 of the one or more first users 104. The user validation subsystem 224 is further configured to compare the one or more fifth data associated with the one or more first users 104 with one or more first prestored data associated with the one or more first users 104 retrieved from one or more clear databases. The user validation subsystem 224 is further configured to generate one or more confidence scores for the one or more first users 104 based on the comparison of the one or more fifth data associated with the one or more first users 104 with the one or more first prestored data associated with the one or more first users 104. The user validation subsystem 224 is further configured to classify the one or more first users 104 based on the one or more confidence scores generated for the one or more first users 104. The user validation subsystem 224 is further configured to determine whether the one or more first electronic devices 106 of the one or more first users 104 need to provide one or more sixth data (i.e., further required information) based on the classification of the one or more first users 104. In an embodiment, the one or more confidence scores may range from 0 to 100. The determination of the required information to be given by the one or more first users 104 based on the one or more confidence scores is given in a below table.

| Confidence Scores | Classification |
|---|---|
| 100 | Match |
| >95 and <100 | May require additional |
| | information |
| 80-95 | Good chance additional |
| | information is needed |
| 79 and below | May require additional |
| | information |

Based on the results received from the clear identity confirm process, the user validation subsystem 224 is configured to show top three responses to the one or more first electronic devices 106 of the one or more first users 104 and allow the one or more first electronic devices 106 of the one or more first users 104 to select which entity they are or to indicate none are correct.

In an embodiment, the below table shows fields/results returned by the clear identity and the fields used in a business model.

| | | | |
|---|---|---|---|
| | | | Used in |
| | | | the |
| Company | Company | Record | Business |
| Entities | Entity | Number | Model |

| | | | |
|---|---|---|---|
| TotalScore | | | Yes |
| EntityIdentifier | | | Yes |
| Summary | | | No |
| SearchRecords | SearchRecord | ContentSource [Business | Yes |
| | | Profile] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |
| | SearchRecord | ContentSource [FEIN] | Yes |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleNam | No |
| | | OfficerAgentLastName | No |
| | SearchRecord | ContentSource [Dan and | Yes |
| | | Bradstreet] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |
| | SearchRecord | ContentSource [Corporate | Yes |
| | | Filing] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |
| | SearchRecord | ContentSource [Business | Yes |
| | | Phone] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |
| | SearchRecord | ContentSource [Phone | Yes |
| | | Record] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |
| | SearchRecord | ContentSource | Yes |
| | | [Worldbase] | |
| | | ContentScore | Yes |
| | | DocumentIdentifier | No |
| | | BusinessName | Yes |
| | | CorporationId | No |
| | | FeinNumber | Yes |
| | | NPINumber | Yes |
| | | DunsNumber | No |
| | | StreetNumber | Yes |
| | | StreetName | Yes |
| | | City | Yes |
| | | State | Yes |
| | | Zipcode | Yes |
| | | Country | No |
| | | OfficerAgentFirstName | No |
| | | OfficerAgentMiddleName | No |
| | | OfficerAgentLastName | No |

In other words, the user validation subsystem 224 is configured to obtain one or more inputs from the one or more first electronic devices 106 of the one or more first users 104. The one or more inputs may include a selection of one or more entities on which the one or more first users 104 are belonging to. The user validation subsystem 224 is further configured to compare the one or more inputs with one or more second prestored data based on a clear risk inform search process. The user validation subsystem 224 is further configured to generate one or more risk scores for the one or more first users 104 based on the comparison of the one or more inputs with the one or more second prestored data. The user validation subsystem 224 is further configured to determine one or more optimum first users based on the one or more risk scores generated for the one or more first users 104. In an embodiment, if the one or more first electronic devices 106 of the one or more first users 104 indicate none of the responses indicating their company, the application corresponding to the one or more first users 104 is marked for a manual review and contact with a new first user. The information of the business that the user validation subsystem 224 checks is given in a below table.

| | |
|---|---|
| Address | No corporate filings tied to business |
| Business License Discipline | Other businesses linked to the business |
| | address |
| Length of time business has been established. | URL/Company website |
| If the company is inactive | Principals and executives tied to |
| | business |
| Global Sanctions | Bankruptcy-business and personal |
| Is it a going concern | Environmental |
| OFAC | Asbestos |
| Other business linked to | Labor and Employment |
| the business phone no. | |
| Pending class action | Lawsuits |
| Suspected out of business | Federal tax liens |
| Corporate filings | State tax liens |
| Doing business as | Miscellaneous liens |
| Industry classification code | Party to risk related lawsuits |
| Google Construction Defect | |

The one or more risk scores for the one or more first users 104 may range from 0 to 100. The lower the risk scores include better results. In an embodiment, optimum user category may range from 0 to 19, an average user category may range from 20 to 30, low user category may range from 31 to 40, and failed user category may range from 41 to 100.

In an embodiment, the user validation subsystem 224 is further configured to check for social media reviews at Google and Yelp, which is given in a below table.

| Scoring | Google | Yelp | |
|---|---|---|---|
| Attribute | Attribute | Attribute | Score Assignment |
| Overall | user_ratings_total | review_count | Assign score as follows: |
| number of | | | No reviews ever: −10, |
| ratings (S1) | | | 1-9 reviews: −5, |
| | | | 10 or more reviews: 0 |
| Overall rating | rating | rating | If total number of ratings is |
| (S2) | | | zero, then assign a score of |
| | | | zero. Otherwise assign score |
| | | | as follows: |
| | | | Overall rating of 1: −10 |
| | | | Overall rating of 2 or 3: −5, |
| | | | Overall rating of 4 or more: 0 |
| Phone number | formatted_phone_{—} | Phone | If the input phone number is |
| same as input? | number | | the same as the phone number |
| (S3) | | | on the API response, then |
| | | | assign a score of 0, else −10. |
| | | | Note: assign a score of −5, if |
| | | | the API response does not |
| | | | return a phone number |
| Zipcode same | zip (from | zip_code | If the input zipcode is the |
| as input? (S4) | formatted_address) | | same as the zipcode on the |
| | | | API response, then assign a |
| | | | score of 0, else −10. |
| | | | Note: assign a score of −5, if |
| | | | the API response does not |
| | | | return a zipcode |
| Is the business | business_status | Not | If value is “OPERATIONAL”, |
| operational? | | applicable | then score = 0, else score = −10. |
| (S5) | | | This attribute applies only to |
| | | | google reviews. |
| | | | For Yelp, assign a score of 0. |

In an embodiment, a next part of the scoring is based on an availability of individual reviews. The user validation system 224 is configured to consider count of ratings in 1 to 3 months as A, count of ratings in 4 to 6 months as B, and total count of ratings as C. The average ratings in 1 to 3 months as X (i.e., average rating would be 0, if no ratings in the time period). The average ratings in 4 to 6 months as Y (i.e., average rating would be 0, if no ratings in the time period). The average ratings in overall is Z (i.e., average rating would be 0, if no ratings ever). In an embodiment, N is a number of months since first rating. In another embodiment, G is a number of 1-star ratings in months 1 to 3.

An algorithm for recent change in the number of ratings (S6) is given below.

If C=0 {
S6=0
}
Else {
If A=0 and B=0: S6 = −0.5
Else: S6 = (A−B)/(C/N); apply a floor and ceiling of {−2, +2}
}

An algorithm for score for recent change in the ratings (S7) is given below.

If C=0 {
S7=0
}
Else {
If A=0 and B=0: S7 = 0
If A>0 and B=0: S7 = X − Z − 0.5
If A>0 and B>0: S7 = min(X − Y, X − Z)
If A>0 and B>0: S7 = Y − Z − 0.5
}

An algorithm for score for recent adverse ratings (S8) is given below.

If C=0 {
S8=0
}
Else {
S8 = (G\hat{ }2/A)*(−1); apply a floor and ceiling of {−10, 0}

The user validation subsystem 224 is configured to determine business risk score (BRS) (i.e., sum of Si to S8) based on overall business risk rating (BRR) as given below.

| | BUSINESS RISK RATING |
|---|---|
| BRS | (BRR) |
| Less than −10 | RED |
| >=−10 and <−5 | AMBER |
| >=−5 and <0 | YELLOW |
| Zero or More | GREEN |

In an embodiment, the AI-based computing system 102 provides initial calibrations for an automated merchant risk rating system. In an embodiment, the AI-based computing system 102 is configured to use total score from a clear ID search API response to determine clear ID search risk rating (CIDSRR) as follows.

| | |
|---|---|
| 100 | Green |
| >95 AND <100 | Yellow |
| 80-95 | Amber |
| <80 | Red |

In an embodiment, the AI-based computing system 102 is configured to use risk inform total score from the clear ID search API response to determine clear risk inform risk rating (CRIRR) as follows.

| 5 or less | Green |
|---|---|
| >5 and <=15 | Yellow |
| >15 and <=20 | Amber |
| >20 | Red |

In an embodiment, the business risk rating (BRR) may be the worst of the four ratings described above. A green BRR may be achieved if all four ratings are green. An yellow BRR rating may be assigned if the worst of the four ratings is yellow. A red rating on any one of the four ratings may result in a BRR of red. In an embodiment, rules for onboarding of the one or more first users 104 are given below.

| BRR | Action |
|---|---|
| Green | Onboard the first user 104, and review |
| | them manually within 3 months |
| Yellow | Onboard the first user 104, and review |
| | them manually within a month |
| Amber | Pend the first user 104, and |
| | approve/decline upon manual review |
| Red | Decline |

In an embodiment, for the one or more first users 104 who are qualified to onboard, the AI-based computing system 102 is configured to display the information based on the business from Clear for verification. If Clear does not have the data, the information inputted by the one or more first users 104 might be displayed. The one or more first users 104 should have the ability to edit the data presented. If the one or more first users 104 materially edits the displayed info name, DBA, city and state of business address, Tax ID number, the AI-based computing system 102 is configured to process the one or more first users 104 again through clear risk inform using the new edited information. The process repeats.

If the one or more first users 104 confirms the data, the AI-based computing system 102 is configured to inform the one or more first users 104 that the one or more first users 104 are approved with additional information. The AI-based computing system 102 receives for an image of their liability insurance declaration page and all business licenses. The images are sent to a provider (TBD) to read and provide the data to the application. If the documents satisfy the requirement, a final approval is given to the one or more first users 104. If the documents do not satisfy the requirements or are unreadable, a manual review of the documents is required.

In an embodiment, the AI-based computing system 102 may send a new communication to the one or more first electronic devices 106 of the one or more first users 104 to indicate that the application is in progress and the application may contact the one or more first users 104. When the one or more first electronic devices 106 of the one or more first users 104 informs the application that none of the top three clear ID confirm entries displayed to the one or more first electronic devices 106 of the one or more first users 104, are accurate. When the application of the one or more first users 104 is pending due to the clear risk inform and/or social media score requires a manual review.

In an embodiment, the AI-based computing system 102 may generate an activity and portfolio performance report, which include at least one of: monthly, quarterly and year to date, a number of applications, by product type and amount, number of approval applications by product type and amount, number of funding of approved applications by product type and amount, fico and Vantage score high, low and median, and loan portfolio including at least one of: number, dollar, weighted average remaining term, weighted average interest rate, number and dollar 30, 60, 90, and 120, number and dollar charged off, number having autopay, number and dollar of loans that have had a UCCI files, and the like.

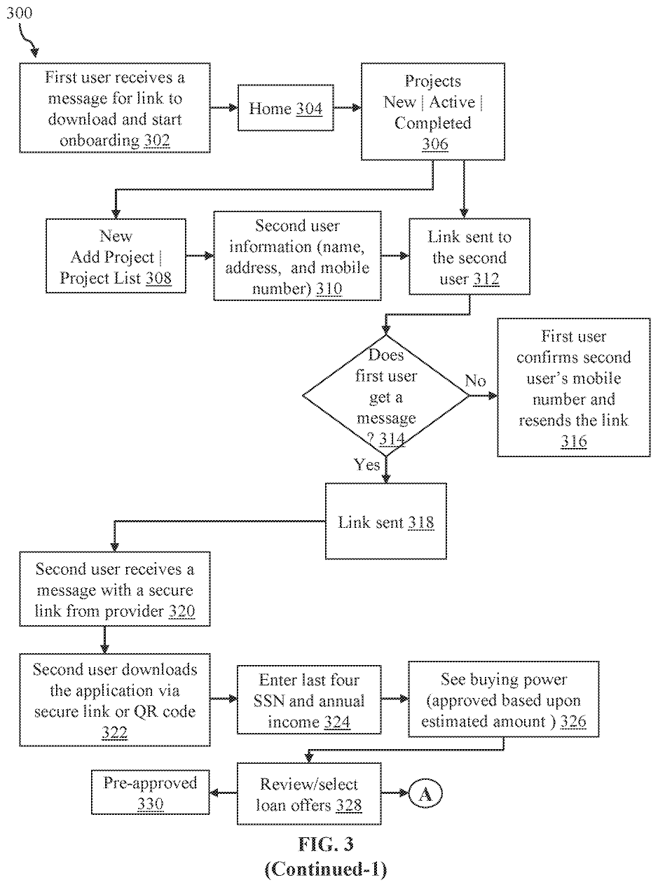

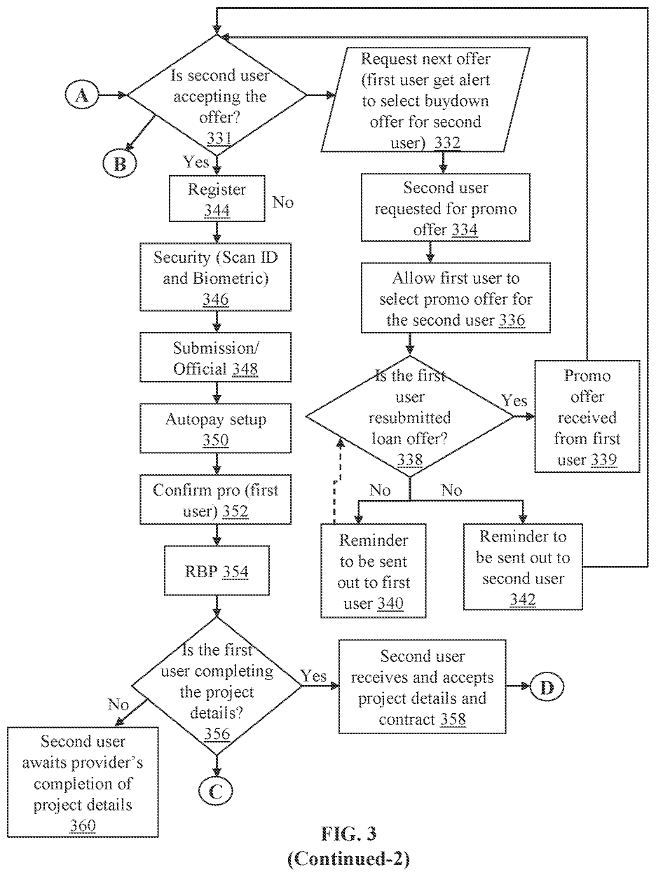

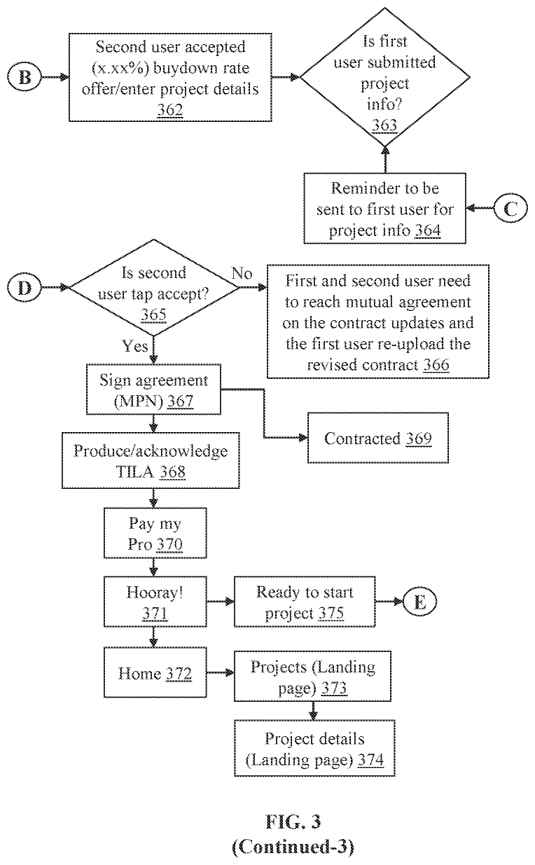

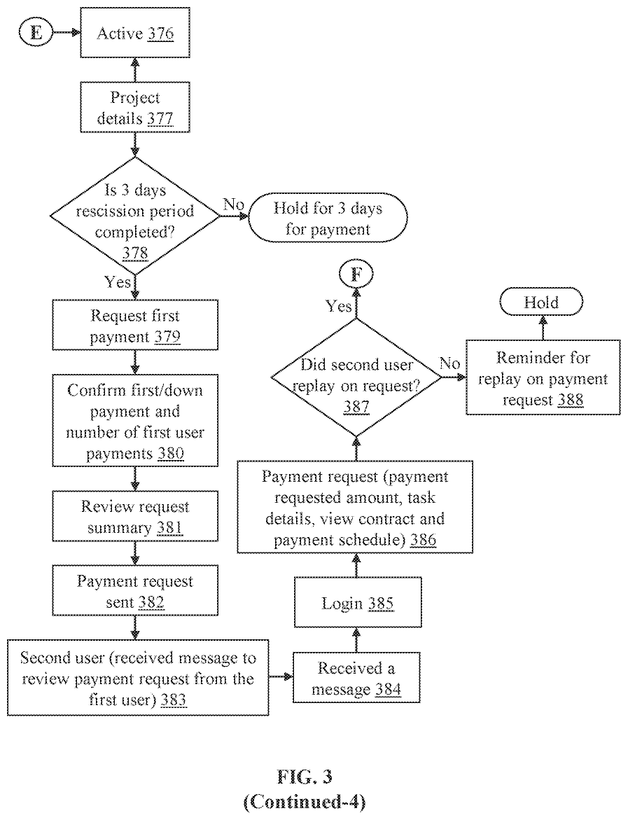

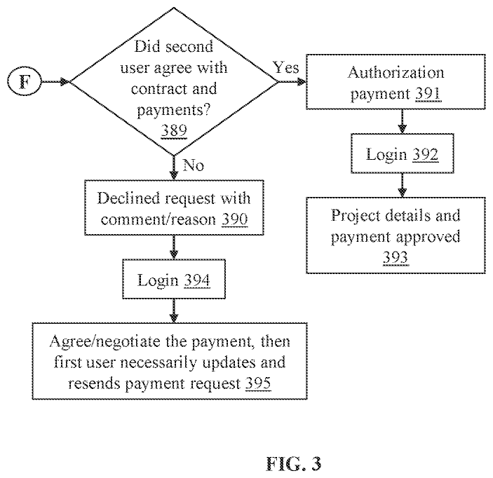

FIG. 3 is an overall process flow 300 of generating the one or more financial applications for the one or more second users 108, in accordance with another embodiment of the present disclosure. At step 302, the one or more first electronic devices 106 of the one or more first users 104 receive the message for the application link to download the application and start onboarding. At step 304, the one or more first users 104 are logged into the application. At step 306, the one or more first electronic devices 106 of the one or more first users 104 select the one or more projects (e.g., new project, active project and completed project). At step 308, the one or more first electronic devices 106 of the one or more first users 104 select the add project option from the screen. At step 310, the one or more first electronic devices 106 of the one or more first users 104 input the information of the one or more second users 108 and the application link is sent to the one or more second electronic devices 110 of the one or more second users 108, as shown in step 312.

At step 314, the AI-based computing system 102 checks whether the one or more second electronic devices 110 of the one or more second users 108 receive a message. If yes, the application link is sent to the one or more second electronic devices 110 of the one or more second users 108, as shown in step 318. If no, the one or more first electronic devices 106 of the one or more first users 104 confirm the mobile number of the one or more second users 108 and resend the application link to the one or more second electronic devices 110 of the one or more second users 108, as shown in step 316. At step 320, the one or more second electronic devices 110 of the one or more second users 108 receive a message with a secure link from the one or more first electronic devices 106 of the one or more first users 104.

At step 322, the one or more second electronic devices 110 of the one or more second users 108 download the application through the secured link or the QR code. At step 324, the one or more second data are received from the one or more second electronic devices 110 of the one or more second users 108. At step 326, the one or more second electronic devices 110 of the one or more second users 108 sees buying power (i.e., approval based on estimated amount). At step 328, the one or more second electronic devices 110 of the one or more second users 108 reviews and selects loan offer (i.e., the first risk-based pricing options). At step 331, the AI-based computing system 102 checks whether the one or more second electronic devices 110 of the one or more second users 108 accept the loan offer. At step 330, the one or more second users 108 are pre-approved for the loan offers.

If the one or more second electronic devices 110 of the one or more second users 108 reject the loan offer, then the one or more first electronic devices 106 of the one or more first users 104 receive alert to select buy down loan offer (i.e., the second risk-based pricing options) for the one or more second users 108, as shown in step 332. At step 334, the one or more second electronic devices 110 of the one or more second users 108 are configured to request for promo offer. At step 336, the one or more first electronic devices 106 of the one or more first users 104 are allowed to select the promo offer for the one or more second users 108. At step 338, the AI-based computing system 102 checks whether the one or more first electronic devices 106 of the one or more first users 104 resubmit the loan offers. If yes, the promo offers are received from the one or more first electronic devices 106 of the one or more first users 104, as shown in step 339. If no, the one or more reminders are sent to the one or more first electronic devices 106 of the one or more first users 104, as shown in step 340, and to the one or more second electronic devices 110 of the one or more second users 108, as shown in step 342.

If the one or more second electronic devices 110 of the one or more second users 108 accept the loan offer, the one or more second electronic devices 110 of the one or more second users 108 are allowed to register the loan processes into the application, as shown in step 344. At step 346, the one or more second electronic devices 110 of the one or more second users 108 are allowed to provide the biometric information and identities associated with the one or more second users 108. At step 348, the one or more second electronic devices 110 of the one or more second users 108 are allowed to submit the identities of the one or more second users 108. At step 350, the one or more second electronic devices 110 of the one or more second users 108 are allowed into the payment processes.

At step 352, the one or more second electronic devices 110 of the one or more second users 108 confirm the one or more first users 104 and the relationship based pricing (RBP) is generated at step 354. At step 356, the AI-based computing system 102 checks whether the one or more first electronic devices 106 of the one or more first users 104 completed the project details. If yes, the one or more second electronic devices 110 of the one or more second users 108 receive and accept the project details and contract, as shown in step 358. If no, the one or more second electronic devices 110 of the one or more second users 108 awaits second user's completion of the project details, as shown in 360.

At step 362, the one or more second electronic devices 110 of the one or more second users 108 may accept the buydown loan offer at x.xx %, when the one or more second electronic devices 110 of the one or more second users 108 do not accept the loan offer, as shown in step 331. At step 363, the AI-based computing system 102 checks whether the one or more first electronic devices 106 of the one or more first users 104 submitted the project information. If the one or more first electronic devices 106 of the one or more first users 104 do not complete the project details, then the reminder communications are sent to the one or more first electronic devices 106 of the one or more first users 104 for the project information, as shown in step 364.

At step 365, the AI-based computing system 102 checks whether the one or more second electronic devices 110 of the one or more second users 108 accept the project details and contract. If no, the one or more first users 104 and the one or more second users 108 need to reach a mutual agreement on the contract updates and the one or more first electronic devices 106 of the one or more first users 104 re-upload the revised contract, as shown in step 366. If yes, the agreement is being signed digitally by the one or more second users 108 through the one or more second electronic devices 110, as shown in step 367. At step 368, the truth in lending agreement (TILA) is generated upon acknowledgement of the signed agreement. At step 369, the one or more first electronic devices 106 of the one or more first users 104 receive a notification indicating the contract between the one or more first users 104 and the one or more second users 108.

At step 370, the one or more second electronic devices 110 of the one or more second users 108 are informed to pay the one or mor first users 104. At step 371, the completion message is being displayed in form of “Hooray!”, and the page turns into home page, as shown in step 372. At step 373, the one or more projects are being displayed on the screen. At step 374, the one or more project details are being displayed on the screen. At step 375, the one or more projects are ready to start. At step 376, the one or more first electronic devices 106 of the one or more first users 104 select the active option of the one or more projects. At step 377, the one or more first electronic devices 106 of the one or more first users 104 retrieve the one or more project details corresponding to the one or more active projects.

At step 378, the AI-based computing system 102 checks whether three days rescission period completed. If no, the process is hold for three days for payment. If yes, the one or more second electronic devices 110 of the one or more second users 108 are requested for making a first payment, as shown in step 379. At step 380, the first down payment and a number of payments made by the one or more first users 104, are confirmed. At step 381, a request summary is being reviewed by the one or more first electronic devices 106 of the one or more first users 104. At step 382, the payment request is sent to the one or more second electronic devices 110 of the one or more second users 108.

At step 383, the one or more second electronic devices 110 of the one or more second users 108 receive the message to review the payment request sent by the one or more first electronic devices 106 of the one or more first users 104. At step 384, the one or more second electronic devices 110 of the one or more second users 108 receive a text message. At step 385, the one or more second electronic devices 110 of the one or more second users 108 are logged into the application. At step 386, the one or more second electronic devices 110 of the one or more second users 108 request for the payment (i.e., request for payment amount, task details, view contract and payment schedule). At step 387, the AI-based computing system 102 checks whether the one or more second electronic devices 110 of the one or more second users 108 replay on the request. If no, the one or more reminder communications are sent for replay on the request, as shown in step 388. If yes, the AI-based computing system 102 checks whether the one or more second users 108 agree with the contract and payments, as shown in step 389. If the one or more second users 108 do not agree with the contract and payments, the request is declined with request or reason, as shown in step 390.

If yes, the authorized payment is made to the one or more second users 108, as shown in step 391. The one or more first electronic devices 106 of the one or more first users 104 receive notification for logging into the application, as shown in step 392, to approve the project details and the payments for the one or more projects, as shown in step 393. The one or more first electronic devices 106 of the one or more first users 104 receive notification for logging into the application, as shown in step 394 when the request is declined. At step 395, the payment is agreed/negotiated and then the one or more first electronic devices 106 of the one or more first users 104 necessarily updates and resends the payment request to the one or more second electronic devices 110 of the one or more second users 108. In FIG. 3, the circular symbol with “A-F” written inside is being used as an off-page connector. This is used for indicating that FIG. 3 continues in the next page.

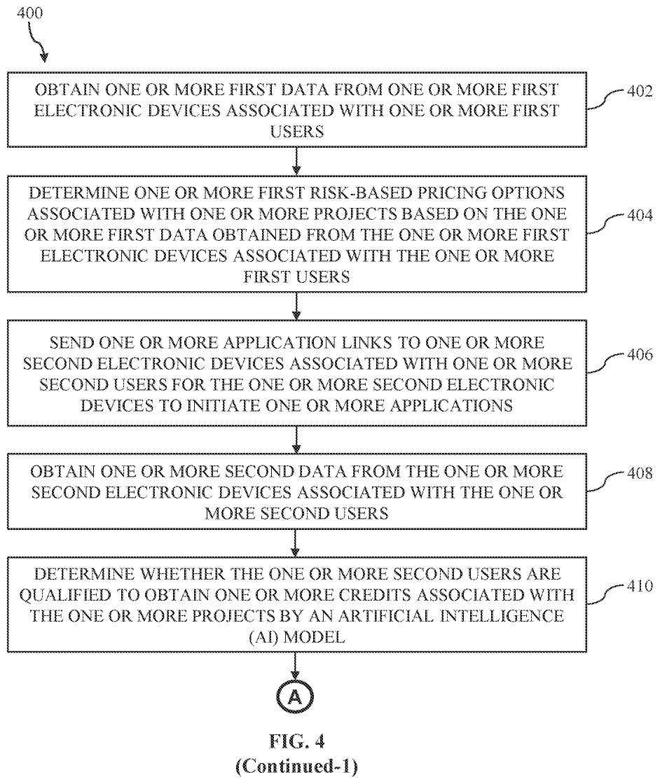

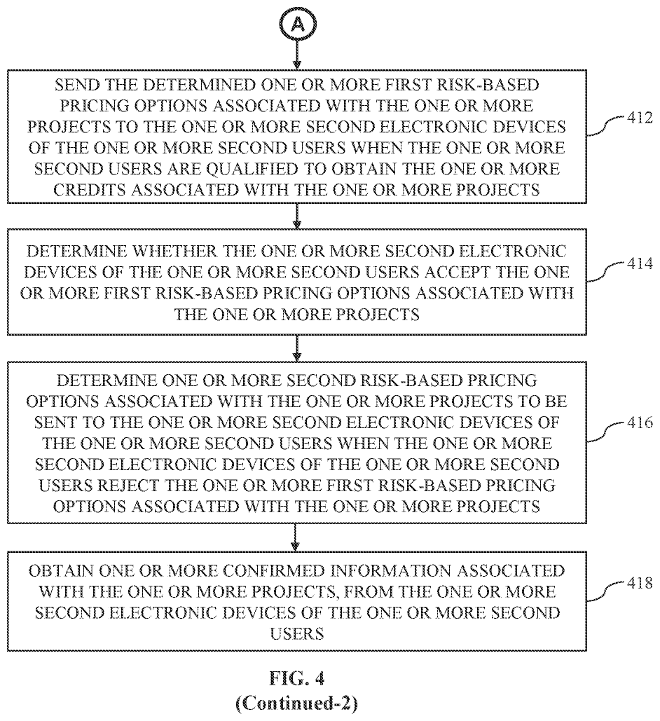

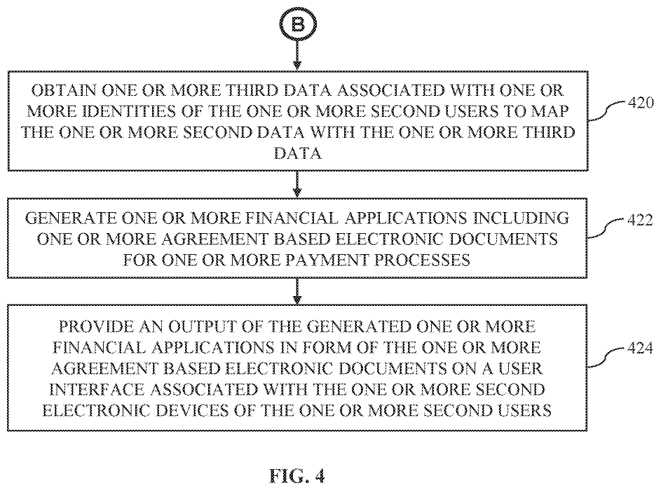

FIG. 4 is a flow chart illustrating an artificial intelligence based (AI-based) computing method 400 for generating the one or more financial applications for the one or more second users 108, in accordance with an embodiment of the present disclosure. At step 402, one or more first data are received from the one or more first electronic devices 106 associated with the one or more first users 104. In an embodiment, the one or more first data may include at least one of: the name, the phone number, and the address, of the one or more second users 108, the one or more project categories, the estimation of one or more projects, and the time duration of the one or more projects being completed.

At step 404, the one or more first risk-based pricing options associated with the one or more projects are determined based on the one or more first data obtained from the one or more first electronic devices 106 associated with the one or more first users 104.

At step 406, the one or more application links are sent to the one or more second electronic devices 110 associated with the one or more second users 108 for the one or more second electronic devices 110 to initiate one or more applications.

At step 408, the one or more second data are obtained from the one or more second electronic devices 110 associated with the one or more second users 108. In an embodiment, the one or more second data may include at least one of: the name, the phone number, the address, at least last four digits of a social security number (SSN), birth date, and annual income, of the one or more second users 108, the amount requested by the one or more second users 108, and the option for one or more third users to be added to the one or more second users 108.

At step 410, the artificial intelligence based (AI-based) computing system 102 determines whether the one or more second users 108 are qualified to obtain one or more credits associated with the one or more projects by the artificial intelligence (AI) model.

At step 412, the determined one or more first risk-based pricing options associated with the one or more projects are sent to the one or more second electronic devices 110 of the one or more second users 108 when the one or more second users 108 are qualified to obtain the one or more credits associated with the one or more projects.

At step 414, the artificial intelligence based (AI-based) computing system 102 determines whether the one or more second electronic devices 110 of the one or more second users 108 accept the one or more first risk-based pricing options associated with the one or more projects.

At step 416, the artificial intelligence based (AI-based) computing system 102 determines the one or more second risk-based pricing options associated with the one or more projects to be sent to the one or more second electronic devices 110 of the one or more second users 108 when the one or more second electronic devices 110 of the one or more second users 108 reject the one or more first risk-based pricing options associated with the one or more projects.

At step 418, the one or more confirmed information associated with the one or more projects, are obtained from the one or more second electronic devices 110 of the one or more second users 108. In an embodiment, the one or more confirmed information associated with the one or more projects may include at least one of: one or more names associated with the one or more first users 104, the one or more categories of works associated with the one or more projects, the estimation of the works associated with the one or more projects, the time duration of the one or more projects, the information associated with one or more ownerships, the one or more categories of one or more properties of the one or more second users 108.

At step 420, the one or more second data associated with one or more identities of the one or more second users 108 to map the one or more second data with the one or more third data. At step 422, the one or more financial applications including the one or more agreement based electronic documents for the one or more payment processes. In an embodiment, the one or more agreement based electronic documents may include at least one of: the information associated with the one or more credit amounts, and the one or more truth in lending agreements (TILA).

At step 424, the output of the generated one or more financial applications in form of the one or more agreement based electronic documents are provided on the user interface associated with the one or more second electronic devices 110 of the one or more second users 108. In FIG. 4, the circular symbol with “A-B” written inside is being used as an off-page connector. This is used for indicating that FIG. 4 continues in the next page.

The present invention has following advantages. The present invention with the AI-based computing system 102 is configured to outline the business requirements for the development of an unsecured consumer loan program that will enable the one or more second users 108 (e.g., the borrowers) to pay for home improvement projects. The present invention is offered through the application and supports the engagement of the one or more first users (e.g., pro/contractor/merchant) 104 and the one or more second users 108.

Further, the present invention is configured to provide a simple, seamless, and secure process for the one or more second users 108 to apply for home improvement financing. The present invention is configured to reduce the time and effort required for the one or more second users 108 to apply for home improvement loans. The present invention is configured to improve the accuracy and efficiency of the home improvement loan approval process.

The present invention is configured to provide a development of the mobile loan application for the one or more second users 108 seeking home improvement loans. The present invention is configured to provide a development of a mobile environment for the one or more first users 104 to create quotes for home improvement projects. The present invention is configured to create the payment process based on the contract and the needs of the two contracting parties (i.e., the one or more first users 104 and the one or more second users 108). The present invention is configured to develop an automated, risk-based onboarding process for participating as the one or more first users 104.

The present invention is configured to provide unsecured consumer loans for home improvement projects to the one or more second users 108 engaged by the one or more first users 104 with whom the lender has an existing relationship. The present invention is configured to enable the one or more second users 108 to submit a loan application through the application and receive prequalification eligibility based on their personal identifiable information (PII). The lender may use soft pull reports from Prove (or Transunion) to determine prequalification eligibility. The one or more second users 108 may view various loan options, and if qualified, will be provided with loan details, including the truth in lending agreement (TILA) that the one or more second users 108 must accept in the course of the application process.

The present invention is configured to introduce the industry's first risk-based, automated activation of the one or more second users 108 under home improvement, leveraging data from various sources (i.e., Thompson Reuter's Clear) including digital, individual, business, professional license, reputational, social, and biometric information.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the AI-based computing system 102 either directly or through intervening I/O controllers. Network adapters may also be coupled to the AI-based computing system 102 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/AI-based computing system 102 in accordance with the embodiments herein. The AI-based computing system 102 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the AI-based computing system 102. The AI-based computing system 102 can read the inventive instructions on the program storage devices and follow these instructions to execute the methodology of the embodiments herein.

The AI-based computing system 102 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. An artificial intelligence based (AI-based) computing method for generating one or more financial applications for one or more second users, the AI-based computing method comprising:
obtaining, by one or more hardware processors, one or more first data from one or more first electronic devices associated with one or more first users, wherein the one or more first data comprise at least one of: name, phone number, and address, of the one or more second users, one or more project categories, estimation of one or more projects, and time duration of the one or more projects being completed;
determining, by the one or more hardware processors, one or more first risk-based pricing options associated with the one or more projects based on the one or more first data obtained from the one or more first electronic devices associated with the one or more first users;
sending, by the one or more hardware processors, one or more application links to one or more second electronic devices associated with the one or more second users for the one or more second electronic devices to initiate one or more applications;
obtaining, by the one or more hardware processors, one or more second data from the one or more second electronic devices associated with the one or more second users, wherein the one or more second data comprise at least one of: the name, the phone number, the address, at least last four digits of a social security number (SSN), birth date, and annual income, of the one or more second users, an amount requested by the one or more second users, and an option for one or more third users to be added to the one or more second users;
determining, by the one or more hardware processors, whether the one or more second users are qualified to obtain one or more credits associated with the one or more projects by an artificial intelligence (AI) model;
sending, by the one or more hardware processors, the determined one or more first risk-based pricing options associated with the one or more projects to the one or more second electronic devices of the one or more second users when the one or more second users are qualified to obtain the one or more credits associated with the one or more projects;
determining, by the one or more hardware processors, whether the one or more second electronic devices of the one or more second users accept the one or more first risk-based pricing options associated with the one or more projects;
determining, by the one or more hardware processors, one or more second risk-based pricing options associated with the one or more projects to be sent to the one or more second electronic devices of the one or more second users when the one or more second electronic devices of the one or more second users reject the one or more first risk-based pricing options associated with the one or more projects;
obtaining, by the one or more hardware processors, one or more confirmed information associated with the one or more projects, from the one or more second electronic devices of the one or more second users, wherein the one or more confirmed information associated with the one or more projects comprise at least one of: one or more names associated with the one or more first users, one or more categories of works associated with the one or more projects, estimation of the works associated with the one or more projects, the time duration of the one or more projects, information associated with one or more ownerships, one or more categories of one or more properties of the one or more second users;
obtaining, by the one or more hardware processors, one or more third data associated with one or more identities of the one or more second users to map the one or more second data with the one or more third data;
generating, by the one or more hardware processors, the one or more financial applications comprising one or more agreement based electronic documents for one or more payment processes, wherein the one or more agreement based electronic documents comprise at least one of: information associated with one or more credit amounts, and one or more truth in lending agreements (TILA); and
providing, by the one or more hardware processors, an output of the generated one or more financial applications in form of the one or more agreement based electronic documents on a user interface associated with the one or more second electronic devices of the one or more second users.

2. The artificial intelligence based (AI-based) computing method of claim 1, further comprising:
selecting, by the one or more hardware processors, the one or more projects from a list of one or more ongoing projects associated with the one or more second users;
generating, by the one or more hardware processors, one or more first options associated with the one or more projects, wherein the one or more first options comprise at least one of: creation of one or more payment requests, one or more update statuses of the one or more projects, one or more updated details of the one or more projects;
obtaining, by the one or more hardware processors, at least one first option associated with the one or more projects selected by the one or more first electronic devices of the one or more first users;
sending, by the one or more hardware processors, the at least one first option selected by the one or more first electronic devices of the one or more first users, to the one or more second electronic devices of the one or more second users;
determining, by the one or more hardware processors, whether the one or more second users accept the at least one first option through the one or more second electronic devices;
initiating, by the one or more hardware processors, the one or more payment processes when the one or more second electronic devices of the one or more second users accept the at least one first option; and
re-sending, by the one or more hardware processors, the at least one first option selected by the one or more first electronic devices of the one or more first users, to the one or more second electronic devices of the one or more second users, upon contacting with the one or more second users through the one or more second electronic devices when the one or more second users reject the at least one first option through the one or more second electronic devices.

3. The artificial intelligence based (AI-based) computing method of claim 1, wherein determining, by the artificial intelligence (AI) model, whether the one or more second users are qualified to obtain one or more credits associated with the one or more projects, comprises:
obtaining, by the one or more hardware processors, the one or more second data from the one or more second electronic devices associated with the one or more second users;
comparing, by the one or more hardware processors, the one or more second data associated with the one or more second users with one or more predetermined data, wherein the one or more predetermined data comprise one or more prestored results associated with one or more qualifications of the one or more second users for the one or more credits based on data associated with the one or more second users; and
determining, by the one or more hardware processors, whether the one or more second users are qualified to obtain the one or more credits associated with the one or more projects, based on the comparison of the one or more second data associated with the one or more second users with the one or more predetermined data.

4. The artificial intelligence based (AI-based) computing method of claim 1, further comprising:
providing, by the one or more hardware processors, one or more second options to the one or more second electronic devices of the one or more second users to add the one or more third users; and
obtaining, by the one or more hardware processors, one or more fourth data associated with the one or more third users from at least one of: the one or more second electronic devices of the one or more second users and one or more third electronic devices of the one or more third users, wherein the one or more fourth data associated with the one or more third users comprise at least one of: the name, the phone number, the address, the at least last four digits of a social security number (SSN), the birth date, and the annual income, of the one or more third users.

5. The artificial intelligence based (AI-based) computing method of claim 1, further comprising:
determining, by the one or more hardware processors, whether the one or more second users hold at least one of: the one or more first risk-based pricing options and the one or more second risk-based pricing options, associated with the one or more projects within a predetermined time duration; and
sending, by the one or more hardware processors, one or more reminder messages to at least one of: the one or more first electronic devices of the one or more first users and the one or more second electronic devices of the one or more second users when the one or more second users hold at least one of: the one or more first risk-based pricing options and the one or more second risk-based pricing options, associated with the one or more projects within the predetermined time duration.

6. The artificial intelligence based (AI-based) computing method of claim 1, further comprising:
generating, by the one or more hardware processors, one or more summaries associated with the one or more credits to be sent to the one or more second electronic devices of the one or more second users upon mapping of the one or more second data with the one or more third data;
determining, by the one or more hardware processors, one or more credit qualifications of the one or more second users based on a hard pull process through a global distribution system (GDS); and
generating, by the one or more hardware processors, the one or more financial applications in the form of the one or more agreements for one or more payment processes when the one or more credit qualifications of the one or more second users exceed one or more predetermined values.

7. The artificial intelligence based (AI-based) computing method of claim 1, further comprising validating, by the one or more hardware processors, the one or more first users based on a clear identity confirm process.

8. The artificial intelligence based (AI-based) computing method of claim 7, wherein validating, by the one or more hardware processors, the one or more first users based on the clear identity confirm process, comprises:
obtaining, by the one or more hardware processors, one or more fifth data associated with the one or more first users from the one or more first electronic devices of the one or more first users;
comparing, by the one or more hardware processors, the one or more fifth data associated with the one or more first users with one or more first prestored data associated with the one or more first users retrieved from one or more clear databases;
generating, by the one or more hardware processors, one or more confidence scores for the one or more first users based on the comparison of the one or more fifth data associated with the one or more first users with the one or more first prestored data associated with the one or more first users;
classifying, by the one or more hardware processors, the one or more first users based on the one or more confidence scores generated for the one or more first users; and
determining, by the one or more hardware processors, whether the one or more first electronic devices of the one or more first users need to provide one or more sixth data based on the classification of the one or more first users.

9. The artificial intelligence based (AI-based) computing method of claim 7, further comprising:
obtaining, by the one or more hardware processors, one or more inputs from the one or more first electronic devices of the one or more first users, wherein the one or more inputs comprise a selection of one or more entities on which the one or more first users are belonging to;
comparing by the one or more hardware processors, the one or more inputs with one or more second prestored data based on a clear risk inform search process;
generating, by the one or more hardware processors, one or more risk scores for the one or more first users based on the comparison of the one or more inputs with the one or more second prestored data; and
determining, by the one or more hardware processors, one or more optimum first users based on the one or more risk scores generated for the one or more first users.

10. An artificial intelligence based (AI-based) computing system for generating one or more financial applications for one or more second users, the AI-based computing system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain one or more first data from one or more first electronic devices associated with one or more first users, wherein the one or more first data comprise at least one of: a name, a phone number, and an address, of the one or more second users, one or more project categories, an estimation of one or more projects, and a duration of the one or more projects being completed;
a risk-based price determining subsystem configured to determine one or more first risk-based pricing options associated with the one or more projects based on the one or more first data obtained from the one or more first electronic devices associated with one or more first users;
a data transmission subsystem configured to send one or more application links to one or more second electronic devices associated with the one or more second users for the one or more second electronic devices to initiate one or more applications;
the data obtaining subsystem configured to obtain one or more second data from the one or more second electronic devices associated with the one or more second users, wherein the one or more second data comprise at least one of: the name, the phone number, the address, at least last four digits of a social security number (SSN), birth date, and annual income, of the one or more second users, an amount requested by the one or more second users, and an option for one or more third users to be added to the one or more second users;
a qualification determining subsystem configured to determine whether the one or more second users are qualified to obtain one or more credits associated with the one or more projects by an artificial intelligence (AI) model;
the data transmission subsystem further configured to send the determined one or more first risk-based pricing options associated with the one or more projects to the one or more second electronic devices of the one or more second users when the one or more second users are qualified to obtain the one or more credits associated with the one or more projects;
the risk-based price determining subsystem further configured to:
determine, whether the one or more second electronic devices of the one or more second users accept the one or more first risk-based pricing options associated with the one or more projects; and
determine one or more second risk-based pricing options associated with the one or more projects to be sent to the one or more second electronic devices of the one or more second users when the one or more second electronic devices of the one or more second users reject the one or more first risk-based pricing options associated with the one or more projects;
the data obtaining subsystem further configured to:
obtain one or more confirmed information associated with the one or more projects, from the one or more second electronic devices of the one or more second users, wherein the one or more confirmed information associated with the one or more projects comprise at least one of: one or more names associated with the one or more first users, one or more categories of works associated with the one or more projects, estimation of the works associated with the one or more projects, the time duration of the one or more projects, information associated with one or more ownerships, one or more categories of one or more properties of the one or more second users; and
obtain one or more third data associated with one or more identities of the one or more second users to map the one or more second data with the one or more third data;
a financial application generation subsystem configured to generate the one or more financial applications comprising one or more agreement based electronic documents for one or more payment processes, wherein the one or more agreement based electronic documents comprise at least one of: information associated with one or more credit amounts, and one or more truth in lending agreements (TILA); and
an output subsystem configured to provide an output of the generated one or more financial applications in form of the one or more agreement based electronic documents on a user interface associated with the one or more second electronic devices of the one or more second users.

11. The artificial intelligence based (AI-based) computing system of claim 10, further comprising a payment processing subsystem configured to:
select the one or more projects from a list of one or more ongoing projects associated with the one or more second users;
generate one or more first options associated with the one or more projects, wherein the one or more first options comprise at least one of: creation of one or more payment requests, one or more update statuses of the one or more projects, one or more updated details of the one or more projects;
obtain at least one first option associated with the one or more projects selected by the one or more first electronic devices of the one or more first users;
send the at least one first option selected by the one or more first electronic devices of the one or more first users, to the one or more second electronic devices of the one or more second users;
determine whether the one or more second users accept the at least one first option through the one or more second electronic devices;
initiate the one or more payment processes when the one or more second electronic devices of the one or more second users accept the at least one first option; and
re-send the at least one first option selected by the one or more first electronic devices of the one or more first users, to the one or more second electronic devices of the one or more second users, upon contacting with the one or more second users through the one or more second electronic devices when the one or more second users reject the at least one first option through the one or more second electronic devices.

12. The artificial intelligence based (AI-based) computing system of claim 10, wherein in determining, by the artificial intelligence (AI) model, whether the one or more second users are qualified to obtain one or more credits associated with the one or more projects, the qualification determining subsystem is configured to:
obtain the one or more second data from the one or more second electronic devices associated with the one or more second users;
compare the one or more second data associated with the one or more second users with one or more predetermined data, wherein the one or more predetermined data comprise one or more prestored results associated with one or more qualifications of the one or more second users for the one or more credits based on data associated with the one or more second users; and
determine whether the one or more second users are qualified to obtain the one or more credits associated with the one or more projects, based on the comparison of the one or more second data associated with the one or more second users with the one or more predetermined data.

13. The artificial intelligence based (AI-based) computing system of claim 10, further comprising a user addition subsystem configured to:
provide one or more second options to the one or more second electronic devices of the one or more second users to add the one or more third users; and
obtain one or more fourth data associated with the one or more third users from at least one of: the one or more second electronic devices of the one or more second users and one or more third electronic devices of the one or more third users, wherein the one or more fourth data associated with the one or more third users comprise at least one of: the name, the phone number, the address, the at least last four digits of a social security number (SSN), the birth date, and the annual income, of the one or more third users.

14. The artificial intelligence based (AI-based) computing system of claim 10, wherein the risk-based price determining subsystem is further configured to:
determine whether the one or more second users hold at least one of: the one or more first risk-based pricing options and the one or more second risk-based pricing options, associated with the one or more projects within a predetermined time duration; and
send one or more reminder messages to at least one of: the one or more first electronic devices of the one or more first users and the one or more second electronic devices of the one or more second users when the one or more second users hold at least one of: the one or more first risk-based pricing options and the one or more second risk-based pricing options, associated with the one or more projects within the predetermined time duration.

15. The artificial intelligence based (AI-based) computing system of claim 10, wherein the financial application generation subsystem is further configured to:
generate one or more summaries associated with the one or more credits to be sent to the one or more second electronic devices of the one or more second users upon mapping of the one or more second data with the one or more third data;
determine one or more credit qualifications of the one or more second users based on a hard pull process through a global distribution system (GDS); and
generate the one or more financial applications in the form of the one or more agreements for one or more payment processes when the one or more credit qualifications of the one or more second users exceed one or more predetermined values.

16. The artificial intelligence based (AI-based) computing system of claim 10, further comprising a user validation subsystem configured to validate the one or more first users based on a clear identity confirm process.

17. The artificial intelligence based (AI-based) computing system of claim 16, wherein in validating the one or more first users based on the clear identity confirm process, the user validation subsystem is configured to:
obtain one or more fifth data associated with the one or more first users from the one or more first electronic devices of the one or more first users;
compare the one or more fifth data associated with the one or more first users with one or more first prestored data associated with the one or more first users retrieved from one or more clear databases;
generate one or more confidence scores for the one or more first users based on the comparison of the one or more fifth data associated with the one or more first users with the one or more first prestored data associated with the one or more first users;
classify the one or more first users based on the one or more confidence scores generated for the one or more first users; and
determine whether the one or more first electronic devices of the one or more first users need to provide one or more sixth data based on the classification of the one or more first users.

18. The artificial intelligence based (AI-based) computing system of claim 16, wherein the user validation subsystem is configured to:
obtain one or more inputs from the one or more first electronic devices of the one or more first users, wherein the one or more inputs comprise a selection of one or more entities on which the one or more first users are belonging to;
compare the one or more inputs with one or more second prestored data based on a clear risk inform search process;
generate one or more risk scores for the one or more first users based on the comparison of the one or more inputs with the one or more second prestored data; and
determine one or more optimum first users based on the one or more risk scores generated for the one or more first users.

19. A non-transitory computer-readable storage medium having instructions stored therein that when executed by a hardware processor, cause the processor to execute operations of:
obtaining one or more first data from one or more first electronic devices associated with one or more first users, wherein the one or more first data comprise at least one of: name, phone number, and address, of the one or more second users, one or more project categories, estimation of one or more projects, and time duration of the one or more projects being completed;
determining one or more first risk-based pricing options associated with the one or more projects based on the one or more first data obtained from the one or more first electronic devices associated with the one or more first users;
sending one or more application links to one or more second electronic devices associated with the one or more second users for the one or more second electronic devices to initiate one or more applications;
obtaining one or more second data from the one or more second electronic devices associated with the one or more second users, wherein the one or more second data comprise at least one of: the name, the phone number, the address, at least last four digits of a social security number (SSN), birth date, and annual income, of the one or more second users, an amount requested by the one or more second users, and an option for one or more third users to be added to the one or more second users;
determining whether the one or more second users are qualified to obtain one or more credits associated with the one or more projects by an artificial intelligence (AI) model;
sending the determined one or more first risk-based pricing options associated with the one or more projects to the one or more second electronic devices of the one or more second users when the one or more second users are qualified to obtain the one or more credits associated with the one or more projects;
determining whether the one or more second electronic devices of the one or more second users accept the one or more first risk-based pricing options associated with the one or more projects;
determining one or more second risk-based pricing options associated with the one or more projects to be sent to the one or more second electronic devices of the one or more second users when the one or more second electronic devices of the one or more second users reject the one or more first risk-based pricing options associated with the one or more projects;
obtaining one or more confirmed information associated with the one or more projects, from the one or more second electronic devices of the one or more second users, wherein the one or more confirmed information associated with the one or more projects comprise at least one of: one or more names associated with the one or more first users, one or more categories of works associated with the one or more projects, estimation of the works associated with the one or more projects, the time duration of the one or more projects, information associated with one or more ownerships, one or more categories of one or more properties of the one or more second users;
obtaining one or more third data associated with one or more identities of the one or more second users to map the one or more second data with the one or more third data;
generating the one or more financial applications comprising one or more agreement based electronic documents for one or more payment processes, wherein the one or more agreement based electronic documents comprise at least one of: information associated with one or more credit amounts, and one or more truth in lending agreements (TILA); and
providing an output of the generated one or more financial applications in form of the one or more agreement based electronic documents on a user interface associated with the one or more second electronic devices of the one or more second users.

20. The non-transitory computer-readable storage medium of claim 19, further comprising:
selecting the one or more projects users from a list of one or more ongoing projects associated with the one or more second users;
generating one or more first options associated with the one or more projects, wherein the one or more first options comprise at least one of: creation of one or more payment requests, one or more update statuses of the one or more projects, one or more updated details of the one or more projects;
obtaining at least one first option associated with the one or more projects selected by the one or more first electronic devices of the one or more first users;
sending the at least one first option selected by the one or more first electronic devices of the one or more first users, to the one or more second electronic devices of the one or more second users;
determining whether the one or more second users accept the at least one first option through the one or more second electronic devices;
initiating the one or more payment processes when the one or more second electronic devices of the one or more second users accept the at least one first option; and
re-sending the at least one first option selected by the one or more first electronic devices of the one or more first users, to the one or more second electronic devices of the one or more second users, upon contacting with the one or more second users through the one or more second electronic devices when the one or more second users reject the at least one first option through the one or more second electronic devices.
